(19) United States
(12) Patent Application Publication
(10) Pub. No.: US 2006/0227768 A1
(43) Pub. Date: Oct. 12, 2006

(54) System and method for communicating between a computer cluster and a remote user interface

(75) Inventors: William F. Sauber, Georgetown, TX (US); Kevin A. Kettler, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/101,243

(22) Filed: Apr. 7, 2005

(51) Int. Cl. H04L 12/50

(52) U.S. Cl. 370/360

(57) ABSTRACT

A system and method for communicating between a local computing resource and a remote user interface includes a segmented switch for sending Peripheral Component Interconnect Express (PCIE) packets. The segmented switch includes a local switch segment that is associated with the local computing resource and a remote switch segment associated with the remote user interface. The local switch segment and the remote switch segment are connected by a link and allow for the transmission of information between the local computing resource and the remote user interface using PCIE packets to transmit keyboard, video and mouse information between the local computing resource and the remote user interface.

### TECHNICAL FIELD

The present invention is related to the field of computer systems and more specifically to a system and method for communicating between a computer cluster node and a remote user interface.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a so called distributed information handling system wherein user interface components (such as the keyboard, mouse and display) are remotely located with respect to the processing resources. The use of a distributed information handling system provides a number of advantages. For instance a distributed architecture allows critical components such as processors and disk drives to be separate from users, thereby impeding removal or alteration of critical components and data or unauthorized software installation. This also simplifies maintenance operations because clusters of computing resources can be clustered in a single location.

However, a distributed computing architecture also presents a number of difficulties—especially in transmitting information between the processing resources and the user interface components. As shown in FIGS. 1A through 1C, described further below, prior attempts and methods of communicating information between a local processing resource and user interface components typically utilize a converter element to employ a conversion or compression scheme to transmit information between the local processing resource and the user interface components.

FIG. 1A, shows an existing system, referred to generally at 10 with a distributed architecture for communicating between a local processing resource (here, standard PC 12) and a remote user interface (keyboard, video, and mouse components 22). Standard PC 12 includes audio and video components 14 which are linked to a local proprietary converter 16. Signals and instructions from standard PC 12 (including information from audio/video component 14) are transmitted to local proprietary converter 16 wherein those signals are formatted into a proprietary scheme to be transferred along point to point connection 18 to remote proprietary converter 20. Information received at remote proprietary converter 20 is then converted back to its original format and sent to user interface 22. Likewise information from keyboard and mouse components of user interface 22 are transmitted to remote proprietary converter 20 where they are converted into a proprietary scheme and sent along point to point connector 18 to a local proprietary converter 16 where they are converted to its original format and sent to standard PC 12.

FIG. 1B shows a second existing system, referred to generally at 30, that includes a local processing resource (standard PC 32) that does not include a graphics controller or a keyboard or a mouse control 32. Local processing resource 32 is linked to a local converter element 34 by PCI Bus 33. Converter 34 converts signals according to a proprietary conversion or compression scheme to be sent to remote converter 38 along custom link 36. Custom link 36 may be a link that incorporates a serialized PCI connection. Information received at remote converter 38 is converted into information which can then be sent to remote user interface 40 via PCI Bus 37. Remote user interface includes both a graphics controller and a video and mouse controller. Additionally, information generated at remote user interface 40 is sent to remote converter 38. This information is then converted for transmittal along PCI bus link 36 and received by local converter 34. This information is then converted to its original format and sent to computer system 32.

FIG. 1C shows another existing system, referred to generally at 50. System 50 includes a local processing resource (standard PC 52) generally in communication with user interface 53, which is remotely located from standard PC 52. Standard PC 52 includes a local converter component 54 and a gigabit Ethernet module 56 and keyboard 64, display 66 and mouse 68. Remote user interface 53 includes a gigabit Ethernet module 60 and a remote converter 62 in communication with local converter 54 and gigabit Ethernet card 56 via gigabit Ethernet connection 58. Information is transmitted along Ethernet connection 58 between converters 54 and 62 utilizing a proprietary conversion and/or compression scheme.

Each of the systems shown in FIGS. 1A, 1B and 1C present significant drawbacks with respect to performance and cost effectiveness and compatibility with standard hardware and software. Each system utilizes a conversion scheme in order to manipulate information that is being transmitted between the local system (12, 32 and 52) and the remote user interface (22, 30 and 63).

### SUMMARY OF THE INVENTION

Therefore a need has arisen for a system and method for communicating between a local computing resource and a remote user interface that provides sufficient speed and bandwidth without requiring a proprietary conversion or compression scheme.

The present disclosure describes a system and method for communicating between a local computing resource and a remote user interface that utilizes a segmented switch for sending Peripheral Component Interconnect Express (PCIE) packets. A segmented switch includes a local switch segment that is associated with the local computing resource and a remote switch segment associated with the remote user interface. The local switch segment and the remote switch segment are connected by a link. The segmented switch allows for the transmission of information between the local computing resource and the remote user interface using PCIE packets to transmit keyboard video and mouse information between the local computing resource and the remote user interface.

In one aspect, the present disclosure describes an information handling system that includes a local computing resource with at least one processor resource and at least one remote user interface that includes one or more addressed components. A segmented switch includes a local switch segment and a remote switch segment. The local switch segment is located at the local computing resource and the remote switch segment is located at the remote user interface. The local switch segment and the remote switch segment are connected by a link. The local switch segment receives PCIE packets from the local computing resource and transmits these packets to the remote switch segment. The remote switch segment then transmits the received PCIE packets to the appropriate addressed component within the remote user interface.

In another aspect a segmented switch for transferring PCIE packets between a local computing resource and a remote user interface includes a local switch segment located at the local computing resource and a remote switch segment located at the remote user interface. The local switch segment and the remote switch segment are connected by a link. The local switch segment is able to receive PCIE packets from the local computing resource and transmit these packets to the remote switch segment. The remote switch segment may then transmit the received PCIE packets to an appropriate addressed component at the remote user interface.

In yet another embodiment a method of communicating between a local computing resource and at least one remote user interface includes providing a segmented switch that has a local switch segment located at a computing resource and a remote switch segment that is associated with a remote user interface. The local switch segment and the remote switch segment are linked together and PCIE packets are received at the local switch segment from the local computing resource and transmitted to the remote switch segment via the link. The PCIE packets are then transmitted to appropriate addressed components at the remote user interface.

The present disclosure includes a number of important technical advantages. One technical advantage is providing a segmented switch with a local switch segment located at the local computing resource and a remote switch segment located at a remote user interface and connected via a link. The use of the segmented switch allows for the transfer of PCIE packets between the local computing resource and the remote user interface using PCIE packets that provide sufficient speed and bandwidth of communication without requiring a complicated compression or conversion operation. Additional advantages will be apparent to those of skill in the art and from the figures, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIGS. 1A, 1B and 1C show examples of existing distributed computing architectures;

FIG. 2 shows an information handling system for communicating information between a local computing resource and a remote user interface according to teachings of the present disclosure;

FIG. 3 shows an information handling system with a distributed architecture according to teachings of the present disclosure;

FIG. 4 shows an information handling system with a distributed architecture according to teachings of the present disclosure;

FIG. 5 shows an information handling system with a distributed architecture according to teachings of the present disclosure;

FIG. 6 shows an information handling system with a distributed architecture according to teachings of the present disclosure;

FIG. 7 shows a segmented switch according to the present disclosure;

FIG. 8 shows a diagram of a segmented switch according to the present disclosure;

FIG. 9 shows a segmented switch according to the present disclosure;

FIG. 10 shows a diagram showing the operation of a segmented switch according to the present disclosure;

FIG. 11 shows a diagram of a packet according to teachings of the present disclosure; and

FIG. 12 shows a diagram of a packet according to teachings of the present disclosure.

### DETAILED DESCRIPTION OF THE INVENTION

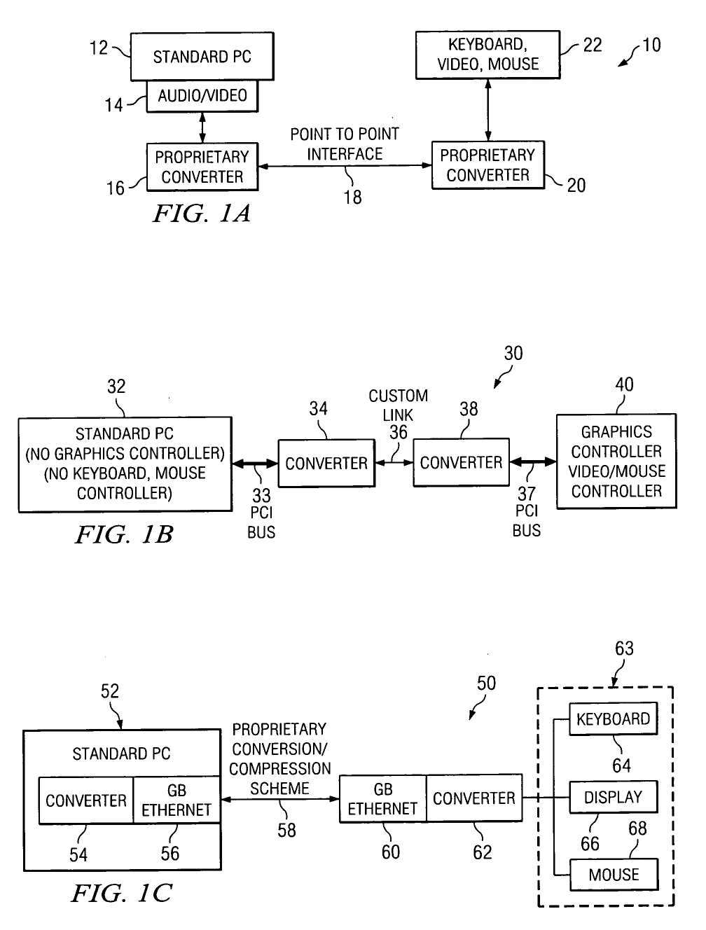

Preferred embodiments of the invention and its advantages are best understood by reference to FIGS. 1-10 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

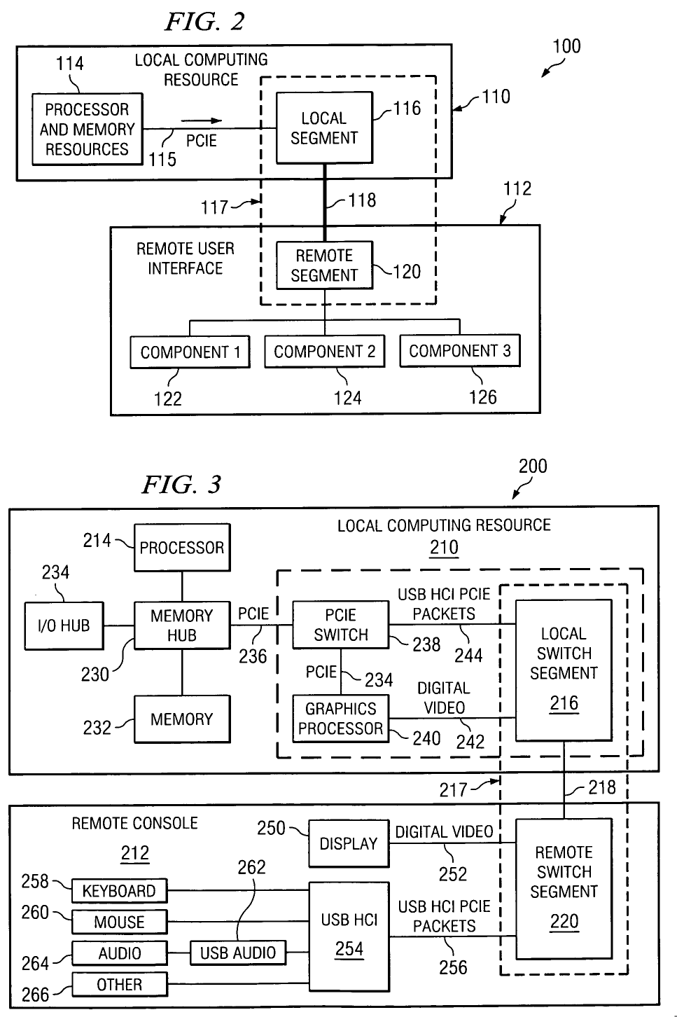

Now referring to FIG. 2, an information handling system according to the present disclosure, referred to generally at 100, is shown. Information handling system 100 includes a local computing resource 110 which may also be referred to as a centralized computer or a cluster node. Information handling system 100 also includes a remote user interface 112 which may also be referred to as a distributed user interface or remote console that is remotely located from local computing resource 110. Local computing resource 110 and remote user interface 12 are in communication via segmented switch 117 as described below. Local computing resource 110 includes processor and memory resource 114 in communication with local switch segment 116 via a connection 115 suitable for sending PCIE (Peripheral Component Interconnect Express) packets from processor and memory resource 114 to local switch segment 116. In the present embodiment a processor and memory resource 114 includes core logic for carrying out the operations discussed herein. Such PCIE packets are preferably formed according to the PCI Express Base Specification, Revision 1.0a which is hereby incorporated by reference. Local switch segment 116 is associated with local computing resource 110 and makes up a portion of segmented switch 117.

Segmented switch 117 includes local switch segment 116 and remote switch segment 120 connected via link 118. Remote switch segment 120 is associated with remote user interface 112. The operation of segmented switch 117 preferably allows the operating system and applications associated with local computing resource 110 and remote user interface 112 to operate with no significant modification. In effect, the operation of segmented switch 117 (and the other segmented switch embodiments described herein) are invisible to the applications and operating system of local computing resource 110 and remote user interface 112.

Remote user interface 112 includes remote switch segment 120 in communication with components 122, 124 and 126. Each component 122, 124 and 126 include an identifying address and may be also be generally referred to as “addressed component.” Components 122, 124 and 126 may comprise any suitable user interface components. In a preferred embodiment, components 122, 124 and 126 may be, for instance, a keyboard component, a mouse component and a display component.

In operation a user preferably is able to access remote user interface 112 via components 122, 124 and 126. Components 122, 124 and/or 126 may then transmit information via to remote switch segment 120. The information is converted into PCIE packets which are then transmitted from remote switch segment 120 to local switch segment 116 via link 118. At local switch segment 116 the received PCIE packets are sent to processor and memory resource 114 along PCIE link 115.

Similarly, information may also be sent from the core logic of processor and memory resource 114 along PCIE connection 115 to local switch segment 116. The PCIE packets are then sent from local switch segment 116 to remote switch segment 120 via link 118. Local switch segment 116, link 118 and remote switch segment 120 operates form segmented switch 117 which facilitates communication between local computing resource 110 and remote user interface 112. Local switch segment 116 and remote switch segment 120 are remotely located with respect to one another. Because link 118 may be an Ethernet link, the length of link 118 may be of any suitable length. Link 118 may also be an Internet Protocol (IP) link, which also allows for link 118 to have any suitable length.

PCIE packets received at remote switch segment 120 are then distributed to the appropriate component based upon the address associated with each PCIE packet received.

FIG. 3 shows an information handling system 200 that includes local computing resource 210 connected to a remote user interface 212 by segmented switch 217. In the present embodiment, information handling system 200 is a more detailed implementation of information handling system 100 described in FIG. 2. Local computing resource 210 includes processor resource 214 in operative communication with memory hub 230. Memory hub 230 is also in operative communication with an input/output (I/O) hub 234 and memory resource 232. Memory hub 230 is in operative communication with PCIE switch 238 via PCIE link 236 for transmitting PCIE packets. In the present embodiment PCIE switch, graphics processor 240 and local switch segment 216 are provided on a graphics card installed within local computing resource 210.

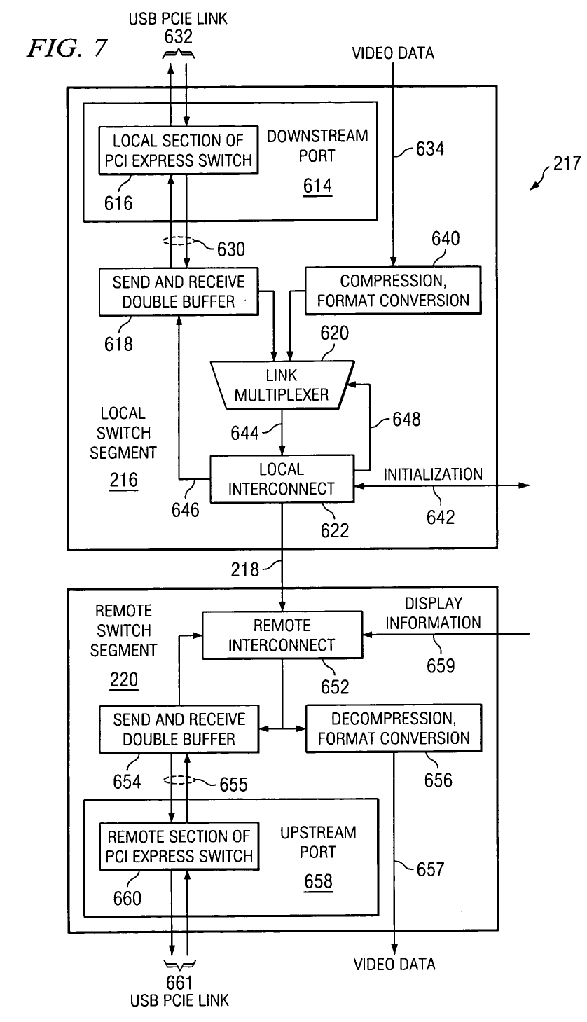

PCIE switch 238 is in operative communication with graphics processor 240 via PCIE link 234. Graphics processor 240 processes video information and sends digital video signals via communication link 242 to local switch segment 216. As described in greater detail in FIG. 7, below, local switch segment 216 includes components using existing compression techniques to compress video signals 242.

In the present embodiment, PCIE switch 238 sends PCIE packets to local switch segment 216 via PCIE link 214, which may transmit PCIE packets. Local switch segment 216 is associated with (and preferably physically disposed at) local computing resource 210. Local switch segment 216 also comprises a portion of segmented switch 217.

Segmented switch 217 comprises local switch segment 216 which may also include a local section of PCI Express switch 616 as shown in FIG. 7. Remote switch segment 220 which may also include (as shown in FIG. 7) a remote section of PCI Express switch module. Local switch segment 216 is connected with remote switch segment 220 via link 218. Link 218 may be of any suitable length and may comprise any suitable type communication line. In at least one preferred embodiment link 218 comprises an Ethernet connection.

Remote user interface includes remote switch segment 220 in communication with display 250 and also is in communication with USB Host Controller Interface (HCI) 254. Display 250 is in operative communication with remote switch segment 220 via connection 252 which is able to send digital video signals from remote switch segment 220 to display 250. USB HCI 254 is in operative communication with remote switch segment 220 via connection 256. Connection 256 allows PCIE packets to be transmitted between USB HCI 254 and remote switch segment 220. USB HCI 254 is further in communication with keyboard component 258, mouse component 260, USB audio module 262 (which is further connected with audio component 264) through USB ports (not expressly shown). USB HCI 254 is also operable to connect with other suitable user interface components 266, also through USB ports.

In the present embodiment processor resource 214 comprises a single processor. In alternative embodiments local computer resource may utilize a plurality (two or more) of processor resources. Storage resource 232, which may also be referred to as memory, may comprise any suitable memory or storage resource. Input/output I/O hub 234 allows for local input and output to local computing resource 210. Memory hub 230 sends and receives information between processor 214, PCI switch 238, memory 232 and input/output hub 234. Specifically, memory hub 230 sends information (in the form of PCIE packets) to PCIE switch 238 via connection 236. Non-video data is then sent via link 244 to local switch segment 216. Graphics video information is sent from PCIE switch 238 to graphics processor 240 via link 239. Graphics processor then processes the video information and transmits digital video information along connection 242 to local switch segment 216.

Local switch segment 216 may then receive digital video information and PCIE packets from graphics processor 240 or PCIE switch 238 which are then sent to remote switch segment 220.

Remote switch segment 220 receives PCIE packets from local switch segment 216 which are then distributed based on their address to either display 250 or to USB HCI 254 where they are then sent to the appropriate user interface component. Remote switch segment 220 also receives PCIE packets from USB HCI 254. These packets are then sent from remote switch segment 220 to local switch segment 216 via link 218 and distributed within local computing resource 210.

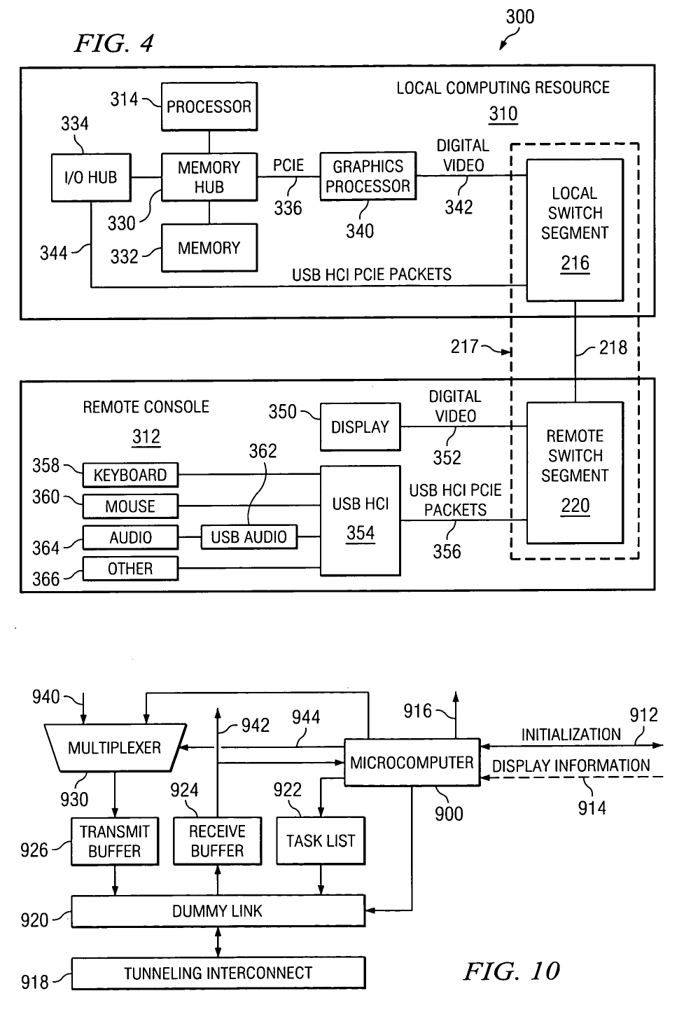

Now referring to FIG. 4, an information handling system generally referred to at 300 that includes a local computing resource 310 and a remote user interface 312 is shown. Local computing resource 310 is connected with remote user interface 312 via segmented switch 217. Segmented switch 217 includes local switch segment 216 and remote switch segment 220 connected via connection or link 218.

Local computing resource 310 includes at least one processor resource 314 in communication with memory 330. Storage resource 332 and I/O hub 334 are also in communication with memory hub 330. Memory hub 330 is operably connected with and may send PCIE packets to graphics processor 340 via connection 336. Graphics processor 340 processes the PCIE packets received from memory hub 330 and transmits digital video information along connection 342 to local switch segment 216. In the present embodiment I/O hub 334 also includes a link 344 to local switch segment 216 allowing a direct connection with I/O hub 334.

Remote user interface 312 includes display component 350 and USB HCI 354. Display 350 is in communication with remote switch segment 220 via connection 352 such that digital video information may be sent from remote switch segment 220 to display 350. USB HCI 254 is in operative communication with remote switch segment 220 via connection 356. Connection 356 allows PCIE packets to be transmitted between USB HCI 354 and remote switch segment 220. USB HCI 354 is further in communication with keyboard component 358, mouse component 360, USB audio module 362 (which is further connected with audio component 364 via USB ports (not expressly shown)). In the present preferred embodiment, USB HCI 354 also connects with other suitable user interface components 266 via USB ports or other suitable ports.

As shown, one significant difference between the embodiment shown in FIG. 3 and the embodiment shown in FIG. 4, is that the embodiment of FIG. 4 provides direct USB connection 344 between I/O hub 334 and local switch segment 216. The components of this embodiment would typically be provided on a single board and would not be provided via a graphics card as shown in FIG. 2. Additionally, the embodiment of FIG. 3 also does not require additional switch component such as switch 238.

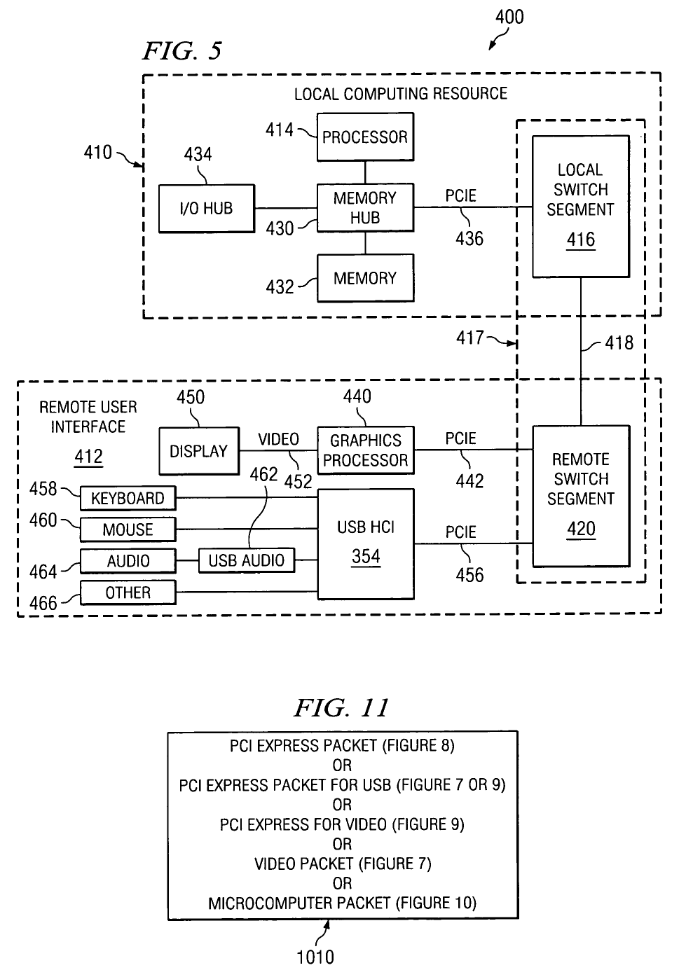

Now referring to FIG. 5 an information handling system generally referred to at 400 is shown. Information handling system 400 generally includes local computing resource 410 connected with remote user interface 412 by segmented switch 417. In the present embodiment local computing resource 410 includes processor resource 414, input output hub 434 and memory or storage resource 432. Memory hub 430 is in operative communication with processor 414, I/O hub 434 and memory 432. Memory hub 430 may also send and receive PCIE packets to local switch segment 416 along connection 436.

Segmented switch 417 includes local switch segment 416 associated with local computing resource 410 and remote switch segment 420 associated with remote user interface 412. Local switch segment 416 and remote switch segment 420 are connected via link 418 such that remote user interface 412 can be remotely located with respect to local computing resource 410.

In the present embodiment, graphics processor 440 is disposed within remote user interface 412 in communication with remote switch segment 420 via PCIE connection 442. Graphics processor 440 may receive PCIE packets from remote switch segment 420. Graphics processor 440 then processes the received packets and sends digital video data to display component 450 along connection 452.

Remote user interface 412 also includes USB HCI 454 which may receive or send PCIE packets to remote user interface via PCIE link 456. USB HCI 454 is in operative communication with addressed remote user interface components such as keyboard 458, mouse 460, USB audio 462 and other components 466 via USB ports (not expressly shown). USB audio component 42 may receive PCIE packets from USB HCI 454 which then transmit audio data to audio component 464 which may be, for instance, a speaker. As shown, one significant difference between information handling system 400 and the information handling systems shown in FIGS. 3 and 4 is that graphics processor 440 is located within remote user interface 412 (instead of being located within local computing resource 410.)

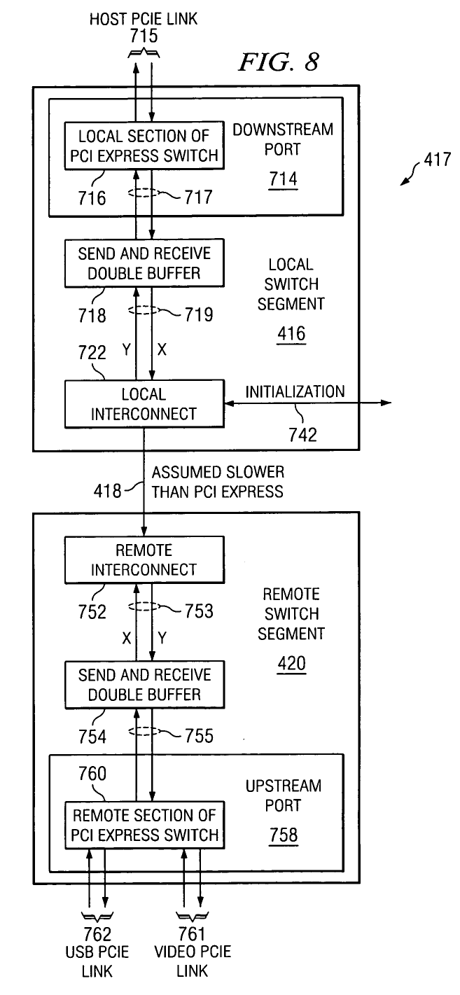

The embodiment shown in FIG. 8 presents some advantages over the embodiment of FIG. 7. Generally, the embodiment of FIG. 8 is less complex than the embodiment of FIG. 7. Additionally the present embodiment may require significantly less bandwidth and be more efficient for certain applications such as word processing applications or other non-graphics-intensive applications.

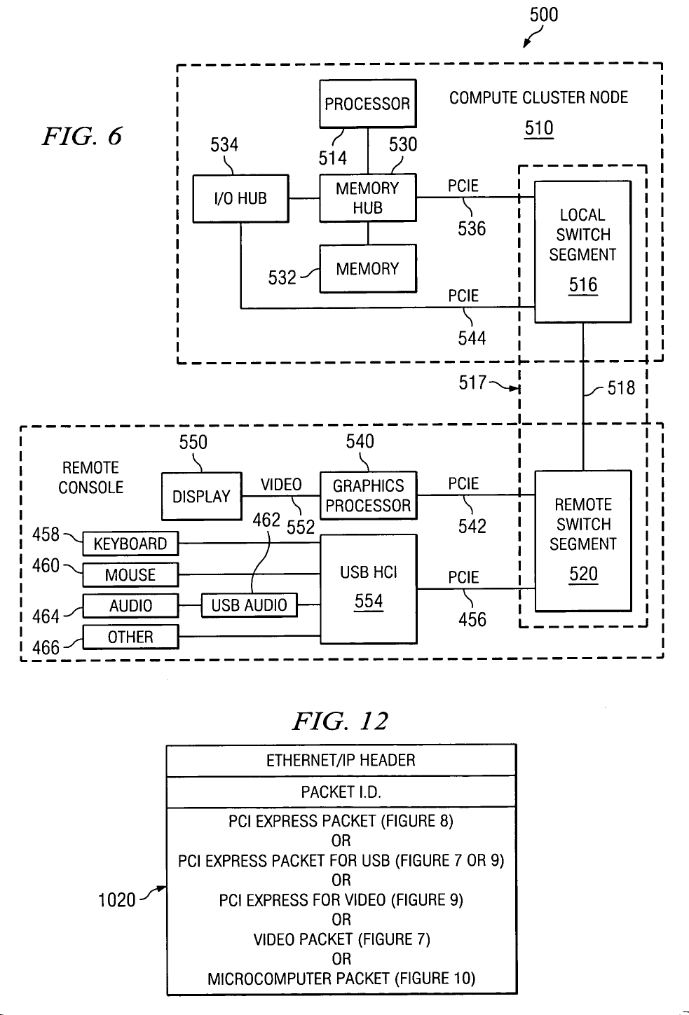

Now referring to FIG. 6 an information handling system generally referred to at 500 is shown. Information handling system 500 generally includes local computing resource 510 connected with remote user interface 512 by segmented switch 517. In the present embodiment local computing resource 510 includes processor resource 514, I/O hub 534 and storage resource 532. Memory hub 430 is in operative communication with processor 514, I/O hub 534 and memory 532. Memory hub 530 may also send and receive PCIE packets to local switch segment 516 along connection 536. In the present embodiment, I/O hub 534 is in direct operative communication with local switch segment 516 to allow for direct communication therebetween.

Segmented switch 517 includes local switch segment 516 associated with local computing resource 510 and remote switch segment 520 associated with remote user interface 512. Local switch segment 516 and remote switch segment 520 are connected via link 518 such that remote user interface 512 can be remotely located with respect to local computing resource 510.

Graphics processor 540 is disposed within remote user interface 512 in communication with remote switch segment 520 via PCIE connection 542. Graphics processor 540 may receive PCIE packets from remote switch segment 520. Graphics processor 540 then processes the received packets and sends digital video data to display component 550 along connection 552.

Remote user interface 512 also includes USB HCI 554 which may receive or send PCIE packets to remote user interface via PCIE link 556. USB HCI 554 is in operative communication with addressed remote user interface components such as keyboard 558, mouse 560, USB audio 562 and other components 566 via USB ports. USB audio component 562 may receive PCIE packets from USB HCI 554 which is then transmitted as audio data to audio component 564, which may be, for instance, a speaker. As shown, one significant difference between information handling system 500 and the information handling systems shown in FIG. 5 is that I/O hub 534 includes a direct link 544 to local switch segment 516 and a direct connection 544 between I/O hub 534 and local switch segment 516.

Now referring to FIG. 7 a segmented switch generally referred to at 217 is shown. Segmented switch 217 includes local switch segment 216 and remote switch segment 220 connected by link 218. The present embodiment of segmented switch 217 may be utilized with either of the information handling systems in FIG. 3 or FIG. 4. Local switch segment 216 includes downstream port 614 (including local section of PCI Express switch 616), buffer element 618 (which is also referred to herein as “double buffer”), link multiplexer 620, video compression and conversion module 640 and local interconnect 622. Local switch segment 216 is connected to remote switch segment 220 via connection 218 as described above. Switch segment 220 includes remote local interconnect 652, send and receive double buffer 654, format conversion module 656 and upstream port 658 (including remote section of PCI Express switch 660). As used herein, a buffer element may comprise any suitable buffer architecture including, but not limited to a single buffer, a double buffer, and a double buffer in each direction of data flow.

In operation segmented switch 217 may be used with, for instance, the distributed computing architectures shown in FIGS. 3 and 4. Downstream port 614 may be in communication with a host (such as memory hub 230) to allow PCIE packets 632 to flow into or out of downstream port 614 and enter the local portion of PCI Express switch 616. Downstream port 614 may be used to disable communication with the host link when double buffer element 618 is full using PCIE flow control. Downstream port includes a local section of PCI express switch 616 which acts to receive and manage PCI express packets entering downstream port 614.

Local section of PCI express switch 616 may send and receive PCI packets to buffer element 618. In the present embodiment, buffer element is a double buffer element that allows a first buffer to be filled while the second buffer is being emptied. In preferred embodiments buffer element includes a double buffer for both data flow directions both into and from local interconnect component 622. PCIE packets received from downstream port 614 by double buffer 618 are, in turn, sent to link multiplexer element 620. Link multiplexer 620 routes data from double buffer 618 to local interconnect component 622. Data is sent from link multiplexer 620 to local interconnect 622 in the direction of arrow 644. Local interconnect 622 allows for a tunneling connection with remote interconnect element 652.

Local interconnect 622 may receive an initialization (or re-initialization) signal or reset signal from connection 642. The reset signal may originate, for example, from General Purpose I/O (GPIO) or SMBus from I/O Hub or graphics controller. Display information signals may be transmitted back to the graphics controller (where the graphics controller is located within the local computing resource, such as in the embodiments of FIGS. 3 and 4).

Local interconnect 622 may send data to link multiplexer 620 along connection 648 and local interconnect 622 may send data to double buffer element 618 along connection 646. Additionally video data may be received at video compression module 640 and then sent to link multiplexer 620 then be forwarded to local interconnect 622.

Switch segment 220 includes remote interconnect 652, which may communicate with local interconnect 622. Remote interconnect 652 is also in communication with video conversion module 656 and send and receive buffer 654. Buffer 654 is similar in function and operation to buffer 618, described above. Double buffer 654 is in communication with the remote section of PCI Express switch 660.

Remote section of PCI Express switch 660 is associated with upstream port 658. Additionally, in the present embodiment remote interconnect 652 may receive display information 659 from the associated display component. Double buffer 654 works in a similar manner to double buffer 618 above. Similarly video conversion module 656 operates to convert video packets to video data 657 to be sent to an associated display component. Display information 659 typically includes information related to the capabilities of the display device associated with the remote user interface (such as display device 250 or 350.)

Information from remote user interface components is typically received at upstream port 658 (or sent therefrom) via USB PCIE link 661. Video conversion modules 640 and 656 may utilize compression or other known conversion techniques. Video conversion module 640 may utilize a memory buffing and timing controller in order to manage the compression or conversion of video data.

Similar to downstream port 614, upstream port 658 may halt communication with the USB PCIE link 661 when one of the two buffers in double buffer 654 is full and the other buffer is not empty. This process will be ensured by issuing the proper number of flow control credits per the PCI express specification. In the present embodiment, local section of PCIE switch 616 within downstream port 614 and remote section of PCIE switch 660 of upstream port 658 manage transmitting and receiving flow control credits. Upstream port 658 transmits data out of one of the received buffers as permitted by PCI Express flow control.

Now referring to FIG. 8 a segmented switch indicated generally at 417 is shown for implementation with an information handling system such as the system 400 shown in FIG. 5. Segmented switch 417 includes local switch segment 416 and remote switch segment 420 connected by link 418. The present embodiment of segmented switch 417 may be utilized with, for instance, information handling system 400 shown in FIG. 5. Local switch segment 416 includes downstream port 714 (including local section of PCI Express switch 716), buffer element 718, and local interconnect 722. Local switch segment 416 is connected to remote switch segment 420 via connection 418 as described above. Switch segment 420 includes remote interconnect 752, buffer element 754 and upstream port 758 (including remote section of PCI Express switch 760).

In operation segmented switch 417 may be used with, for instance, the distributed computing architecture shown in FIG. 5. Downstream port 714 may be in communication with a host (such as memory hub 430) to allow PCIE packets 715 to flow into or out of downstream port 714 and enter the local portion of PCI Express switch 716. Downstream port 714 may be used to disable communication with the host link when buffer element 718 is full. Downstream port includes a local section of PCI express switch 716 which acts to receive and manage PCI express packets entering downstream port 714. Local section of PCI express switch 716 may also be referred to as a local controller.

Local section of PCI express switch 716 can send and receive PCI packets to buffer element 718 via connection 717. In the present embodiment, buffer element 718 comprises a simple double buffering system that allows a first buffer to be filled while the second buffer is being emptied. In preferred embodiments buffer element 718 includes a double buffer for both data flow directions both into and from local interconnect component 722. PCIE packets received from downstream port 714 by double buffer 718 are, in turn, sent to (and received from) local interconnect component 722 via connection 719. Local interconnect 722 allows for a connection with remote interconnect element 752 within remote switch segment 420. Local interconnect 722 may receive an initialization (or re-initialization) signal or reset signal from connection 742.

Switch segment 420 includes remote interconnect 752, which communicates with local interconnect 722. Remote interconnect 752 is also in communication with buffer 754. Buffer 754 is similar in function and operation to buffer 718, described above. Buffer 754 is in communication with the remote section of PCI Express switch 760, which may also be referred to as a remote controller.

Remote section of PCI Express switch 760 is associated with upstream port 758. Information from remote user interface components is typically received at upstream port 758 (or sent therefrom) via USB PCIE link 762 or video PCIE link 761.

Similar to downstream port 714, upstream port 758 may halt communication with the USB PCIE link 762 or video PCIE link 761 when one of the two buffers in buffer 654 is full and the other buffer is not empty. This process proceeds by utilizing flow control credits per the PCI express specification.

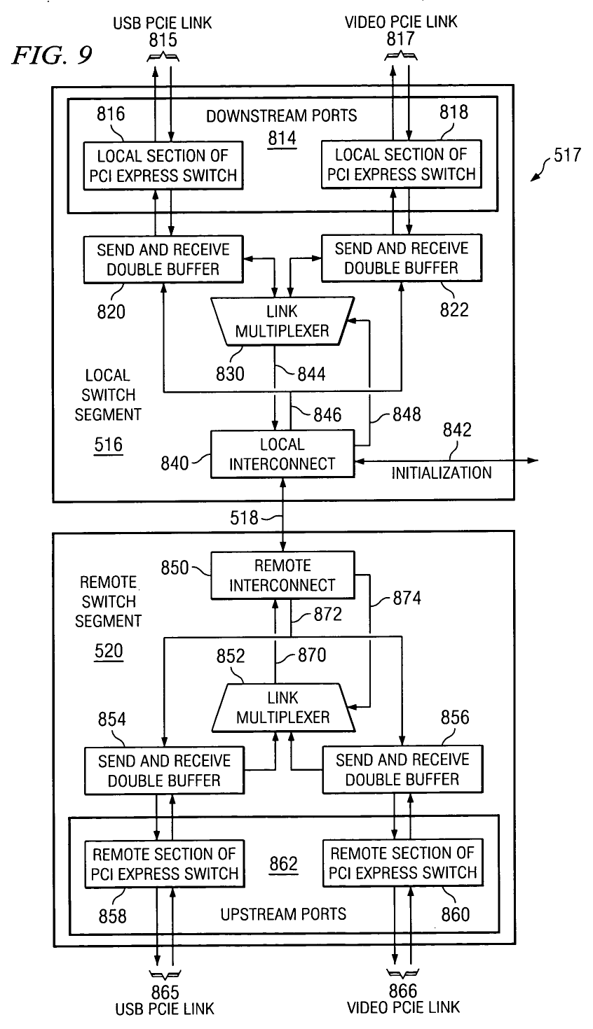

Now referring to FIG. 9, a segmented switch generally referred to at 517 is shown. Segmented switch 517 includes local switch segment 516 and remote switch segment 520 connected by link 518. The present embodiment of segmented switch 517 may be utilized with, for instance, information handling system 500 shown in 6. Local switch segment 516 includes downstream ports 814 (including local sections of PCI Express switch 816 and 818), buffer elements 820 and 822, link multiplexer 830 and local interconnect 840.

Local interconnect 840 is connected to remote interconnect 850 via connection 518. Remote switch segment 520 includes remote interconnect 850, link multiplexer 852, send and receive buffers 854 and 856, and upstream ports 862. Upstream ports 862 include remote sections of PCI Express switch 858 and 860 for communicating with USB PCIE link 865 and Video PCIE link 866, respectively.

In operation, segmented switch 517 may be used with the distributed computing architecture shown in FIG. 6. Downstream ports 814 may be used to disable communication with a host link when an associated buffer element (such as buffer 820 or 822) is full. Downstream ports 814 may include first local PCI switch section 816 for communication with a host (such as memory hub 530) to allow PCIE packets 815 to flow into or out of local section of PCI Express switch 816. Downstream port 814 also includes second local PCI switch section 818 for communication with a host to allow PCIE packets 817 containing video information to flow into or out of second local section of PCI Express switch 818. Packets received at either local section 816 or 818 from a local computing resource are sent to (or received from) an associated respective buffers 820 or 822. Buffers 820 and 822, in turn send PCIE packets to link multiplexer 830. In the present embodiment, buffer elements 820 and 822 preferably comprise double buffer elements that each allow a first buffer to be filled while a second buffer is being emptied. In preferred embodiments, each buffer element may include a double buffer for both data flow directions.

Link multiplexer 830 routes packets to local interconnect component 840. Data is sent from link multiplexer 830 to local interconnect 840 in the direction of arrow 844. Local interconnect 840 allows for a tunneling connection with remote interconnect element 850 (via link 518.)

Local interconnect 840 may receive an initialization (or re-initialization) signal or reset signal from connection 842. Local interconnect 840 may send control signals to link multiplexer 830 along connection 848. Alternately, local interconnect 840 may send data (and control signals) to buffer elements 820 and 822 along connection 846.

Remote switch segment 520 includes remote interconnect 850 that preferably communicates with local interconnect 840. Remote interconnect 850 is also in communication with multiplexer 852 and buffers 854 and 856. Buffers 854 and 856 are similar in function and operation to buffers 820 and 822, above. Buffers 854 and 856 are in communication with the first remote section of PCI Express switch 858 and the second remote section of PCI Express switch 860, respectively. First remote section 858 may communicate PCIE packets over USB PCIE link 865; second remote section 860 preferably communicates PCIE packets containing video data over link 866.

Similar to downstream port 814, upstream port 862 may disable further communication with the USB PCIE link 865 or video PCIE link 866 when one of the respective double buffers 858 or 860 is full and the other buffer is not empty. This process will be ensured by issuing the proper number of flow control credits per the PCI Express specification.

Now referring to FIG. 10, a diagram showing data flow associated with local or remote interconnects according to the present disclosure, is shown. Microcomputer 900 receives initialization data on link 912 and display information on link 914 for the remote interconnect. Microcomputer 900 also monitors incoming data the microcomputer acts as a controller within the switch segment.

Microcomputer 900 may receive incoming data from tunneling interconnect 918, via receive buffer 924. In the present embodiment, tunneling interconnect 918 is preferably an Ethernet connection. Microcomputer 900 may communicate with task list 922 to communicate with an Ethernet controller. Microcomputer 900 transmits data to multiplexer 930 such that multiplexer 930 may assemble PCIE packets in appropriate format. Such packets are then sent to transmit buffer 926. Transmit buffer 926 is used to hold completed packets before they are sent to dummy link 920. Dummy link 920 is an interface with tunneling interconnect 918. In particular, dummy link 920 facilitates the interface when tunneling interconnect 918 is an Ethernet Controller and preferably also includes an EEPROM (electrically erasable programmable read-only memory) and other related Ethernet components. In such instances, tunneling interconnect 918 will operate as if transmit buffer 926, receive buffer 924 and task list 922 are memory components. Dummy link 920 serves to provide access to these “memory components.” Dummy link 920 may be used to interface to a standard Ethernet controller by emulating a PCIE or PCI interface. Task list 922 facilitates communication between microcomputer 900 and tunneling interconnect 918, preferably in a standardized manner. Packets received by tunneling interconnect 918 are sent to receive buffer 924 (via dummy link 920). Receive buffer 924 preferably may contain multiple packets and allows simultaneous data reception and transfer to destination.

On the local side, initialization data 912 may include a reset and may also include advice from the host on how to divide link access time between the two streams of data as described in FIGS. 3, 4 and 6. The presence of data in the buffers coupled with such advice may preferably be used to determine how multiplexer 930 is controlled via connection 916. On the remote side, advice on link access priority for the embodiment shown in FIG. 6 would be provided by the host and transmitted through a special packet created by the local microcomputer and may select between data from graphics processor 540 and USB HCI 554.

Standard display capability information is preferably provided to remote microcomputer 900 through a standard display interface 914. Remote microcomputer 900 formats packets to transmit display data (e.g., Electronic Display Interface Data, EDID) back to the host through local microcomputer 900. For the embodiments shown in FIGS. 3 and 4, Initialization Connection 912 may be a suitable connection such as, but not limited to, an SMBus. In some embodiments, display connection 914 is an I²C interface.

For the embodiments shown in FIGS. 3, 4 and 6 microcomputer 900 preferably merges data with source information in packets acceptable to the tunneling interconnect block 918, and monitors and removes destination information received from tunneling interconnect 918. Source information received on the destination site determines the destination.

Microcomputer 900 provides two inputs to multiplexer 930. One of the inputs provides standard Ethernet packet information including the destination Ethernet controller address. For example, in the present embodiment, preprogrammed MAC addresses are used. Alternative embodiments may use any suitable addressing scheme. The remote MAC address may preferably be provided to the local microcomputer by the host during initialization. The local MAC address may be provided to the remote microcomputer through a special packet. In one embodiment the remote microcomputer may delay transmissions until such a special packet was received prior to completing initialization. Alternatively, the microcomputer may implement an entire IP stack, and association of local to remote interfaces may be dynamic based on user identification.

A destination address is also merged into the destination packet by microcomputer 900. This address is simply a reflection of the control bits 916 and 944 generated by the microcomputer 900 for multiplexer 930 and multiplexers 620, 830 and 852 previously discussed. Another input to multiplexer 930 from microcomputer 900 is control bit 944.

The delivered data within the Ethernet packet identifies the destination of the data. For the systems shown in FIGS. 3 and 4, there is only one destination for incoming data not intercepted by the microprocessor 900 on the local side. For the system shown in FIG. 5, the destination on the remote side is determined by standard PCI Express routing techniques. Microcomputer 900 monitors the incoming packets. No destination is enabled during Ethernet packet header data, but error detection and retry may be implemented. The delivered data address is captured by microcomputer 900 and used to enable a destination for data transfer. In the event that a standard Ethernet controller is used, communication with buffers 924 and 926 will be controlled through task list 922.

FIG. 11 shows an example of a packet 1010 entering multiplexer 930 via input 940. FIG. 12 shows an example of an assembled packet 1020 which would be transmitted/received by tunneling interconnect 916 of FIG. 10.

The packet ID in 1020 is used by microcomputer 900 to indicated or determine the source or destination of the packet. For example, in FIG. 7, source/destinations 618, 640, 654, 656 or microcomputer 900 in FIG. 10 would be identified. In FIG. 8, source/destinations 718, 754 or microcomputer 900 in FIG. 10 would be identified.

Although the disclosed embodiments have been described in detail, it should be understood that various changes, substitutions and alterations can be made to the embodiments without departing from their spirit and scope.

What is claimed is:

1. An information handling system comprising:
a local computing resource having at least one processor resource;
at least one remote user interface having at least one addressed component;
a segmented switch having a local switch segment and a remote switch segment in communication via a link, the local switch segment associated with the local computing resource and the remote switch segment associated with the at least one remote user interface;
the local switch segment operable to receive PCIE (Peripheral Component Interconnect Express) packets from the local computing resource and transmit the PCI Express packets via the link to the remote switch segment;
the remote switch segment operable to transmit the received PCIE packets to an appropriate addressed component;
the remote switch segment operable to transmit PCIE packets received from the at least one addressed component to the local switch segment.

2. The information handling system of claim 1 wherein the local computing resource comprises a cluster node.

3. The information handling system of claim 1 wherein the local computing resource comprises:
at least one storage resource;
an input/output (I/O) resource; and
a memory hub in communication with the at least one storage resource, the input/output resource and the at least one processor resource; and
the memory hub operable to transmit or receive PCI Express packets.

4. The information handling system of claim 1 wherein the local computing resource further comprises a graphics processor.

5. The information handling system of claim 1 wherein the plurality of addressed components comprise a display component, a keyboard component, and a mouse component.

6. The information handling system of claim 1 wherein the link comprises an Ethernet connection.

7. The information handling system of claim 1 wherein the link comprises an Internet Protocol (IP) link.

8. The information handling system of claim 1 wherein the remote user interface comprises:
a graphics processor communicatively coupled with the remote switch segment and operable to receive PCIE packets from the remote packet interface; and
a display component communicatively coupled with the graphics processor operable to receive video data therefrom.

9. The information handling system of claim 1 wherein:
the local switch segment comprises a local controller;
the remote switch segment comprises a remote controller; and
the local controller and the remote controller operable to manage packet flow between the local switch segment and the remote switch segment.

10. The information handling system of claim 9 wherein the remote user interface comprises:
a host controller operable to send PCIE packets to the remote switch segment;
at least one remote user input component communicatively coupled with the host controller; and
the host controller operable to convert input data from the at least one input component into a PCIE packet format.

11. The information handling system of claim 1 wherein the host controller comprises a USB host controller.

12. The information handling system of claim 1 wherein the operation of the processor resource requires no modification to communicate with the segmented switch.

13. A segmented switch for transferring PCIE packets between a local computing resource and a remote user interface comprising:
a local switch segment associated with the local computing resource;
a remote switch segment associated with the remote user interface;
the local switch segment and the remote switch segment in communication via a link;
the local switch segment operable to receive PCIE packets from the local computing resource and transmit the PCI Express packets via the link to the remote switch segment; and
the remote switch segment operable to transmit the received PCIE packets to an appropriate addressed component.

14. The segmented switch of claim 12 wherein the link is an Ethernet connection.

15. The segmented switch of claim 13 wherein the link is an Internet Protocol (IP) link.

16. A segmented switch for transferring PCIE packets between a first computing resources and a second computing resource comprising:
a first switch segment associated with the first computing resource;
a second switch segment associated with the second computing resource;
the first switch segment and the switch segment in communication via a link;
the first switch segment to receive PCIE packets from the first computing resource and transmit the PCIE packet in the link to the remote switch segment; and
the second switch segment operable to transmit the received PCIE packets to an associated addressed component.

17. A method for communicating between a local computing resource and at least one distributed user interface comprising:
providing a segmented switch having a local switch segment associated with a computing resource having at least one processor resource and a remote switch segment associated with the remote user interface having at least one addressed component;
linking the local switch segment and the remote switch segment;
receiving PCIE packets at the local switch segment from the local computing resource;
transmitting the PCIE packets to the remote switch segment via the link; and
transmitting the PCIE packets received at the remote switch to an appropriate associated addressed component.

18. The method of claim 17 further wherein the local computing resource comprises a graphics processor.

19. The method of claim 17 wherein the distributed user interface comprises a graphics processor.

20. The method of claim 17 wherein the link comprises an Ethernet connection.

21. The method of claim 17 wherein the link comprises an Internet Protocol (IP) link.
